(19) United States
(12) Patent Application Publication
(10) Pub. No.: US 2012/0318211 A1
(43) Pub. Date: Dec. 20, 2012

(54) Animal body harness

(76) Inventors: Christina E. Madonna, North Hyde Park, NY (US); Cathy Ann Madonna, North Hyde Park, NY (US)

(21) Appl. No.: 13/134,806

(22) Filed: Jun. 17, 2011

(51) Int. Cl. A01K 27/00

(52) U.S. Cl. 119/792

(57) ABSTRACT

An animal harness is provided including a back strap, a belly strap, a waist strap, and a neck strap. The animal harness provides for greater control and adjustability of the harness while providing for improved comfort of the animal and reduced stress associated with use of the harness. The animal harness also provides for efficient use of materials for improved performance of the device while providing for ease of use.

### FIELD OF THE INVENTION

This invention is related to animal body harnesses, and more particularly related to dog body harnesses for use with a leash.

### BACKGROUND OF THE INVENTION

Animal body harnesses are often used to assist with the handling of an animal, such as a dog, and can be used with a leash or other restraining line. Body harnesses provide for control of an animal without causing as much stress to the animal as neck collars can cause. A common problem with existing harnesses is the shifting of the harness as an animal moves, which results in discomfort to the animal and reduced control of the harness for the handler. In addition, existing harnesses lack adjustability, such as may be needed to adjust a harness to provide a better fit for a particular animal's size, physique and/or personality. To the extent that some harnesses provide for some adjustability, such harnesses fail to provide the benefits of the existing invention, including efficient use of materials, improved placement of connection and adjustment devices, and other functional aspects which provide for greater comfort for the animal and improved control for the handler.

Accordingly, there is a need for an improved animal harness which provides for improved control and which provides for efficient use of materials.

### OBJECTS OF THE INVENTION

It is an object of the invention to provide an animal harness which is durable, readily cleanable, and easy to use. Another object of the invention is to provide an animal harness which is adaptable for use with dogs, which does provides greater control of the dog and less stress than existing harnesses. It is a further object of the invention to provide an animal harness design providing for efficient use of materials while ensuring improved performance for each control element of the device.

It is an object of the invention to provide a harness which enable adjustable control over a neck region of an animal. It is also an object of the invention to provide a harness which enable adjustable control over a belly waist region of an animal. It is a further object of the invention to permit the neck and waist control aspects to cooperate to provide for distributed control and to reduce the stress experienced by the animal.

Another object of the invention is to utilize wide flexible webbing material at specific control surfaces for added comfort to the animal. It is a further object of the invention to provide for greater stability of the harness to prevent slipping of the harness on the animal. Another object of the invention is to ensure proper application of control forces to the intended areas of the animal, such as the neck and waist. It is a further object to provide stiffer materials at the back and or belly strap to provide for greater stability and reduce the slippage of the harness on the animal.

A further object of the invention is to provide a harness with a reliable and durable design. It is a further object of the invention to provide buckles which allow for dependable and long lasting connection. Another object of the invention is to choose connection and adjustment devices which reducing material while maintaining at least a minimal degree of dependability in maintaining the connection.

It is a further object to provide an additional waist strap to distribute pressure to neck and waist when an animal is pulling on a leash, and thereby reduce stress to the animal. It is a further object of the invention to reduce stress to the animal by placing a harness having a connection which avoids putting direct pressure on the animal's neck. It is a further object of the invention to avoid the application of compressive stresses to the back of the back of the animal.

### SUMMARY OF THE INVENTION

An animal harness according to the invention is provided comprising a back strap, a belly strap, a waist strap, and a neck strap. The belly strap includes at least one belly strap connector. The back strap is connected in a fixed manner to the waist strap. The belly strap includes at least one belly strap connector, and is slidably connected to the waist strap by the belly strap connector. The belly strap is connected to a ring connector of the neck strap in a fixed manner. The neck strap includes at least one neck strap adjuster.

Alternative embodiments can include a number of variations. In one embodiment, the back strap is connected to the neck strap in a fixed manner at a midpoint of the neck strap, and can be connected at a ring connector. In another embodiment, the neck strap includes a neck strap stiffener such as where the neck strap connects with the back strap.

A further embodiment can have a back strap which includes a back strap attachment and a back strap stiffener. In addition, the back strap stiffener an also include or be provided as a strap length adjuster. One embodiment of the strap length adjuster can have at least one tongue disposed on one side of back strap with a hook and loop connector, wherein a portion of the hook and loop connector is disposed on a portion of the back strap. In an alternative embodiment, the strap length adjuster can include a length of back strap material, a buckle, and a slider; wherein the length of back strap material is looped around the neck connector ring.

In a further embodiment, the waist strap includes a strap length adjuster disposed at one end of the waist strap near the back strap and on an opposite side of the waist strap fastener so as to be located on the opposite side of the animal when worn. In addition, waist strap stitching can be provided near to and above the male connector.

In another embodiment, the belly strap includes a belly strap stiffener. Furthermore, the belly strap can include a strap length adjuster. The strap length adjuster can include a length of belly strap material, a buckle, and a slider; wherein the length of belly strap material is looped around the belly strap attachment ring.

In an alternative embodiment, the neck strap includes two neck strap length adjusters, each on either side of the neck strap. In addition, each neck strap length adjuster can comprise a length of neck strap material, a slider and a buckle. Each neck strap length is adjustably connector to the belly strap attachment.

### BRIEF DESCRIPTION OF THE DRAWINGS

Preferred embodiments of the inventive devices are illustrated in the drawings and are described below, though not necessarily to scale.

FIG. 1 illustrates a side view of an embodiment of an animal harness according to the invention.

FIG. 2 illustrates a perspective view of an embodiment of a belly strap for use with an animal harness according to the invention.

FIG. 3 illustrates a perspective view of an embodiment of a waist strap for use with an animal harness according to the invention.

FIG. 4 illustrates a bottom view of an embodiment of an animal harness according to the invention.

FIG. 5 illustrates a top view of an embodiment of an animal harness according to the invention.

FIG. 6 illustrates a perspective view of an embodiment of an animal harness according to the invention with use with a dog.

FIG. 7 illustrates a side view of an embodiment of an animal harness according to the invention.

FIG. 8 illustrates a side view of an embodiment of an animal harness according to the invention.

FIG. 9 illustrates a perspective view of an embodiment of a belly strap for use with an animal harness according to the invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

A detailed description of an animal harness is provided below for general applicability. In addition, several specific embodiments are provided as examples of the devices which one of ordinary skill in the art may apply these teachings to address specific problems and to illustrate the benefits and improvements of the system over known solutions.

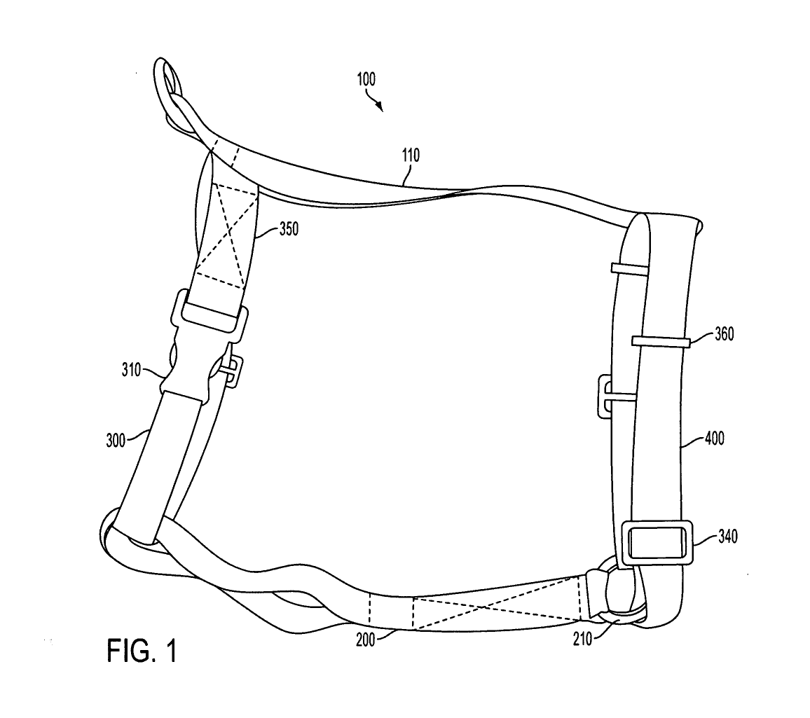

FIG. 1 shows a side view of an embodiment of an animal harness 100 according to the invention. An animal harness 100 includes a back strap 110, a belly strap 200, a waist strap 300, and a neck strap 400. The back strap 110 is connected at its front portion to the neck strap 400 at a top portion of the neck strap 400. The back strap 110 is connected at its back portion to the waist strap 300 at a top portion of the waist strap 300. The belly strap 200 is connected at its front portion to the neck strap 400 at a bottom portion of the neck strap 400. The belly strap 200 is connected at its back portion to the waist strap 300 at a bottom portion of the waist strap 300.

By providing a neck strap 400 and waist strap 300, the harness is provided with at least two points of control of the animal, at its front end and at its back end. In addition, by providing a back strap 110 and belly strap 200, the neck strap 400 and waist strap 300 can be connected whereby forces exerted at the front of the animal can be distributed to the rear of the animal and forces exerted at the rear of the animal can be distributed to the front of the animal. Furthermore, by connecting the back strap 110 at a top portion of the waist strap and neck strap, and by connecting the belly strap 200 to a bottom portion of the waist strap and neck strap, control forces can be maintained along the spinal axis of the animal, thereby reducing stress to the animal.

The straps can be fabricated from flexible webbing, such as nylon webbing, and connected by stitching, buckles, clasps and other such materials as further described herein. Preferably the webbing material and connectors are color coded to provide for ease of use. For example, the webbing for the body of the harness can be one color other than black and the belly strap can be of black webbing. This ensures ease of use for the pet owner. The two tone color system allows the pet owner to identify the belly strap therefore making it easy to know top from bottom and how to put the harness on the animal properly.

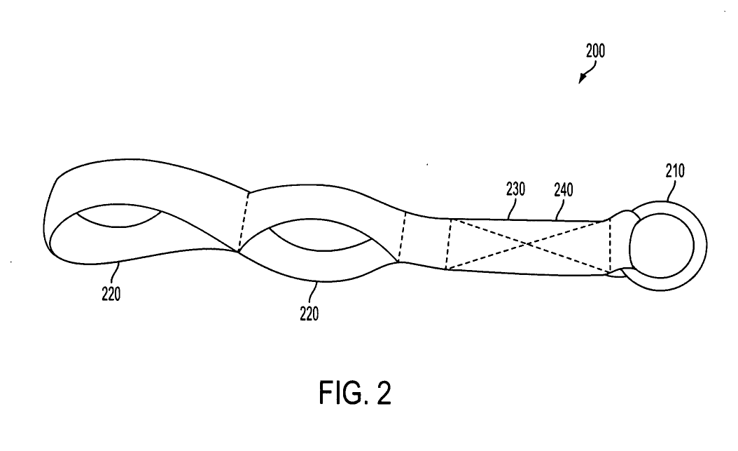

FIG. 2 shows an embodiment of a belly strap 200 according to the invention. The belly strap 200 is preferably comprised of a ribbon of material and can be fabricated from a length of polyester webbing as a loop of material that has been double-backed upon itself at each end and stitched together to form loops in the material. Each loop of material is preferably sized to fit the diameter of a waist strap 300 to be passed through at least one of the loops to form a flexible connection. The belly strap 200 includes a belly strap attachment 210 at a front portion at the belly strap 200 for flexibly connecting the belly strap to the neck strap 400. The belly strap attachment 210 preferably comprises a ring and can be connected to the belly strap 200 by a loop of material of the belly strap 200. The belly strap 200 can also include one or more belly strap connectors 220 disposed at a back portion of the belly strap 200 to provide a flexible connection between the belly strap and the waist strap. Each belly strap connector 220 is preferably formed as a loop of material of the belly strap 200 sufficient to permit a portion of the waist strap 300 to pass through the belly strap connector 220 and thereby provide a better fit of the harness on the animal. The belly strap 200 can also include belly strap stitching 240 for connecting one or more portions of the belly strap 200, as well as a belly strap stiffener 230 for stiffening at least a portion of the belly strap 200.

An embodiment of a harness according to the invention preferably comprises a combination of fixed and flexible connections for connecting the back strap, belly strap, neck strap and waist strap. Preferably at least one fixed connection is included to provide stability in at least one the of the control portions of the harness 100. For example, in one embodiment, a fixed connection is provided at the connection of the waist strap and back strap, which is proximate to the connection of the harness to the leash, and flexible connections provided in other portions of the harness, such as at the connection of the neck strap and back strap, and connection of the belly strap and waist strap which can be flexible connections. In such a manner, improved control can be provided with a minimum of fixed connections without sacrificing comfort and flexibility which can be provided by flexible connections.

In addition, an embodiment of a belly strap connector 220 according to the invention preferably comprises at least one slidable connection, such as the loops provided by the belly strap for providing a flexible connection to the waist strap. The loops 220 in the belly strap provide a flexible connection to the waist strap without the stiffness use of a fixed connection, such as cross stitching, or the hard material of other flexible connectors, such as a ring connector 210. By providing a flexible connection of soft flexible webbing material, the harness avoid creating unnecessary irritation to the animal at a sensitive portion of its body, without sacrificing control and while avoiding the use of unnecessary material.

In addition, the belly strap 200 is preferably connected to the neck strap 400 by a fixed connection such as ring connector 210. The ring connector 210 permits forces to be distributed along either side of the animal's neck as it moves by permitting the connections to either side of the neck strap 400 to slide on the ring. In addition, whereas existing neck straps often comprise a collar encircling an animal's neck, by providing the connection ring 210, the belly strap can connect to the neck strap at an area proximate to the breastbone and away from the jugular region of the animal's neck, whereby the belly strap and two sides of the neck strap can meet at the ring connector 210 to form the shape of a V, thereby more efficiently distributing forces and improving the control of the harness without sacrificing comfort to the animal. In addition, the ring connector 210 enables the neck strap to be attached to the animal without requiring duplicative connections.

Furthermore, an embodiment of the belly strap can optionally include a stiffened portion 230, such as by providing cross-stitching 240 of the webbing material, at an area proximate to the ring connector 210. By providing the stiffened portion, great control is provided whereby the connector ring can be kept in place and shifting of the neck strap is avoided. It can be appreciated that in the alternative, or in addition to the stiffened portion 230, an adjuster can be provided, as described more fully below.

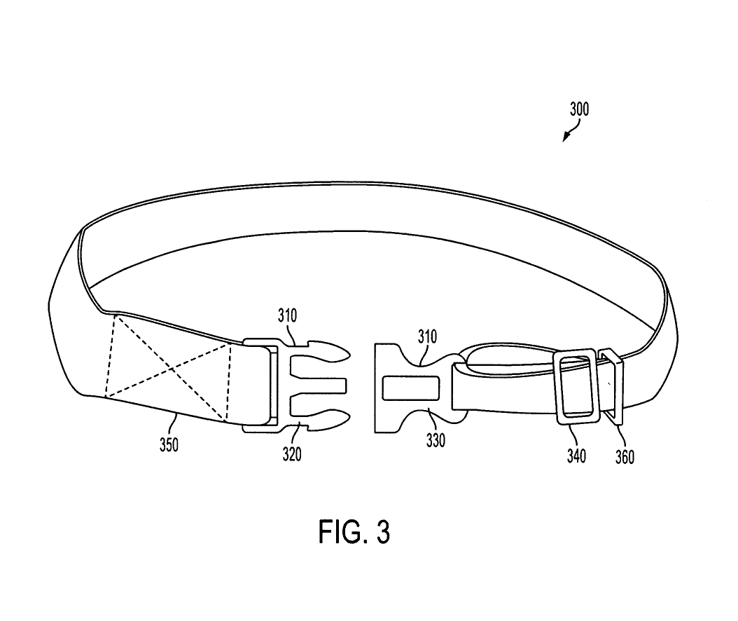

FIG. 3 shows an embodiment of a waist strap 300 according to the invention. The waist strap 300 is preferably comprised of a ribbon of material, such as a length of polyester webbing. A waist strap 300 includes a waist strap fastener 310 for connecting a first and second end of the waist strap 300, and thus permits the back portion of the harness to be attached to the animal. The connector can be provided as a buckle having a male connector 320 portion and a female connector 330 portion. The male connector 320 is preferably provided at a top end of the waist strap 300 and the female connector 330 provided at a bottom end of the waist strap 300. In addition, a stiffened portion 350 can be provided. The male connector 320 is preferably connected to the waist strap 300 at a stiffened portion 350 of the waist strap 300 and is tightly connected to the waist strap 300. Accordingly, waist strap stitching 350 can be provided at a stiffened portion of the waist strap 300 which facilitates the placement of the harness on the animal, among other things. By providing the male connector at a top end, and the female connector at a bottom end, the harness avoids the unintentional release of the waist strap such as when the loop of the belly strap may slide the buckle and apply downward force to one or both of the release portions of the buckles. Thus by providing the male connector at top, at least some upward force against the release portions of the buckle can be required, and thereby prevent unintentional release of the harness.

In addition, the male connector 320 is preferably connected to the waist strap 300 at a top end of the waist strap, and the waist strap fixedly connected to the back strap so that the fastener 310 is disposed approximately at a half-way point of the side of the animal, or at or above at a half-way point on one side of the waist strap, so that the fastener 310 does not become caught in the belly strap connector 220 of the belly strap, or released by a hind foot of the animal. Accordingly, the waist strap fastener can remain in the same position on the back of the animal. In addition, the waist strap can provide that the female portion of the connector can slide easily through the double loop belly strap and does not get hung up on the belly strap.

The waist strap 300 also includes a strap length adjuster 340 for adjusting the length of the waist strap 300. The adjuster 340 provides a means for adjusting the length of the waist strap and can includes a number of known means such as those used for belts and collars. Preferably, the adjuster 340 comprises a ring or buckle which can hold the strap material by friction or other means. For example, the ring can have an intermediate portion around which the strap can be fed. In addition, a strap slider 360 can be provided to hold one or more portions of the strap. For example, the strap slider 360 can be a circular or rectangular ring which can receive a double-backed portion of the material of the waist strap 300 and/or can be integrated with the strap length adjuster 340, and thus provide a means for adjusting the length of the waist strap 300 and locking the waist strap 300 at a desired length. The female connector 330 can be connected to the waist strap 300 by a loop of material of the waist strap 300, with a double backed portion of the strap held by the adjuster 340 for the strap.

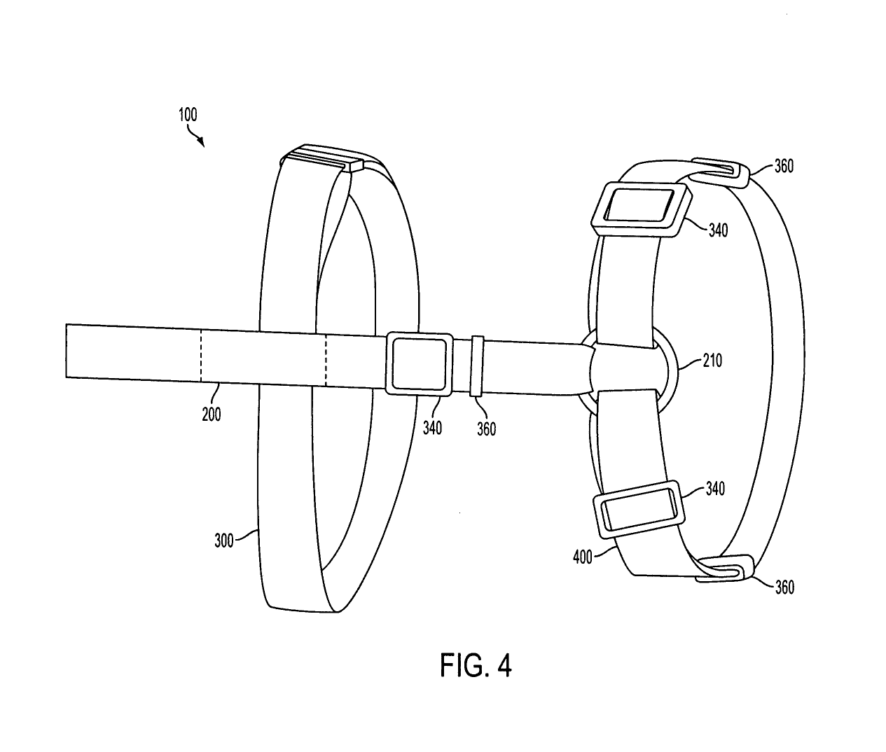

FIG. 4 shows a bottom view of a harness 100 according to the invention, showing portions of a neck strap 400, and portions of a waist strap 300, among other things. The back strap is not shown in FIG. 4 to avoid confusion. The neck strap 400 includes at least one strap length adjuster 340. In addition, the neck strap 400 can include at least one adjuster slider 360 to receive a free end of a loop of the material that has been double-backed through the adjuster 340. Preferably two strap length adjusters 340 are provided, one at either end of the neck strap 400 so that they can be evenly connected to the belly strap connector 210, such as an O-ring, whereby each end of the neck strap 400 can form a loop around the connector 210. By providing two neck strap length adjusters 340, a neck strap can be fixedly connected to the back strap 110 at a midpoint of the neck strap 400, and the neck strap evenly adjusted by adjusting both neck strap length adjusters 340. Each neck strap adjuster 340 can receive a loop of the neck strap material to fixedly hold one end of the strap by friction or other means. The neck strap adjuster slider 360 can be used to hold a loose portion of a loop that has been passed through the length adjuster to the neck strap, and prevent the loop from becoming tangled or caught by the animal fur, appendages or other items. The adjuster can be provided to engage a portion of a loop of material in a locked position and release the loop in order to adjust the length of the neck strap. It can be appreciated the different forms of adjusters 340 and sliders 360 can be provided, such as buckles, snaps, toothed rings, dual rings, split rings, clips, and pins, and combinations thereof, among other things.

In a further embodiment of a harness according to the invention, the belly strap 200 can be provided with a length adjuster 340 and/or slider 360, which can be in addition to or as a replacement for a stiffener 230 and which can be used to adjust the length of the belly strap 200. In one embodiment of a length adjuster, wherein a length of webbing is looped around a ring or other fastening, and is double-backed to a buckle, the end of the webbing can be stitched or otherwise connected to an intermediate point on the webbing, or the end of the webbing can remain loose. In a latter form of the embodiment of the length adjuster, the free end of the belly strap 200 can be disposed on the animal side of the harness to prevent the animal from freeing the loose end of the belly strap.

It can be appreciated that the length adjuster 340 and slider 360, can be disposed on the webbing material in different positions relative to one another. For example, in a form of the embodiment of the length adjuster, wherein the free end of the belly strap 200 is fastened such as by stitching to a portion of the webbing, the slider 360 can be disposed proximate the ring connector and the length adjuster disposed further away along from webbing from the ring connector.

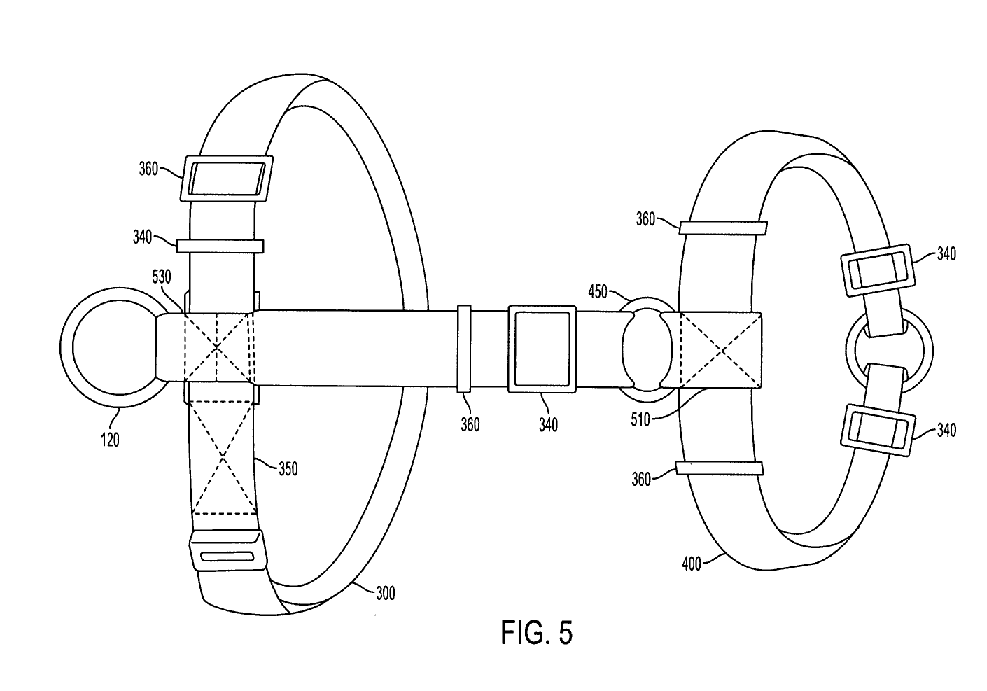

In a further embodiment of a harness 100 according to the invention, the harness can be made more lightweight by providing two sets of simple adjusters 340 and sliders 360 for the neck strap 400, which together they can provide an adequately secure control around the animal's neck while providing a lightweight means of adjusting the length of the neck strap at either side. In addition, by providing the neck strap fixedly connected to a ring connector 450 which connects to the back strap, as shown in FIG. 5, the harness avoids the neck strap from shifting around the animal's neck.

FIG. 5 shows a top view of an embodiment of a harness according to the invention, showing the back strap 110 and a top portion of a neck strap 400 and waist strap 300. The belly strap is not shown in FIG. 5 to avoid confusion. The back strap 110 can be connected to the neck strap 400 at a mid-portion of the neck strap. In one embodiment, the back strap 110 is connected to the neck strap 400, such as by a ring connector 450, to provide flexibility of the connection, while maintaining the position of the connection in a fixed location at the neck strap. Alternatively, the neck strap can be fixedly connected to the back strap, such as by providing cross-stitching. In addition, the back strap 110 is fixedly connected to the waist strap 300, such as by cross-stitching the webbing material, at a mid-portion of the waist strap.

In one embodiment of a harness 100 according to the invention, a neck connection stiffener 510 can be provided at a portion of the neck strap connecting the neck strap to the flexible connection to the back strap such as a connector ring 450. The stiffener 510 can be provided by doubling back a length of webbing material and connecting the material such as by cross-stitching. In addition, or in the alternative, a stiffener 510 can be provided along at least a portion of the back strap. In addition or in the alternative, the back strap can be provided with a back strap stiffener 130 proximate to the stiffener 510, each of which can be provided as a box stitch to keep the back strap rigid and prevent the harness from shifting from side to side on the animal.

In addition, an embodiment of the back strap 110 can be provided with a length adjuster 340. The length adjuster 340 can comprise a loop of material of the back strap and a strap slider 360, and can provide a means for adjusting the length of the back strap 110 and locking the back strap 110 at a desired length. The strap slider 360 can be a circular or rectangular ring which can receive a double-backed portion of the material of the back strap 110 to keep excess material from interfering with the animal. In addition, the back strap length adjuster 340 can be used instead of or in addition to a stiffener 510 along the back strap as a doubled-back length of material used in a length adjuster can provide the desired additional stiffness.

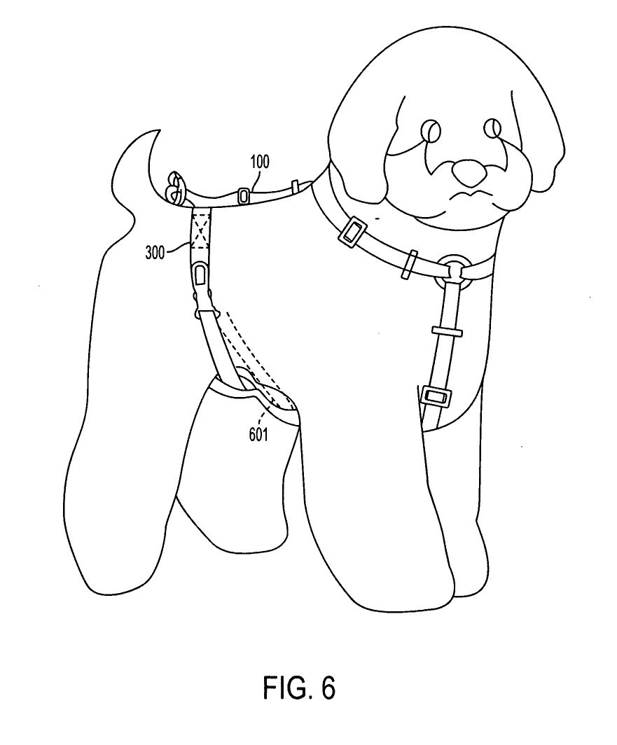

FIG. 6 shows a perspective view of a harness according to the invention for use with a dog. As shown the waist strap 300 can be provided in a distal loop of the belly strap connector 200. Alternatively, the waist strap 300 can be provided in an alternative loop 601 of the belly strap connector 220.

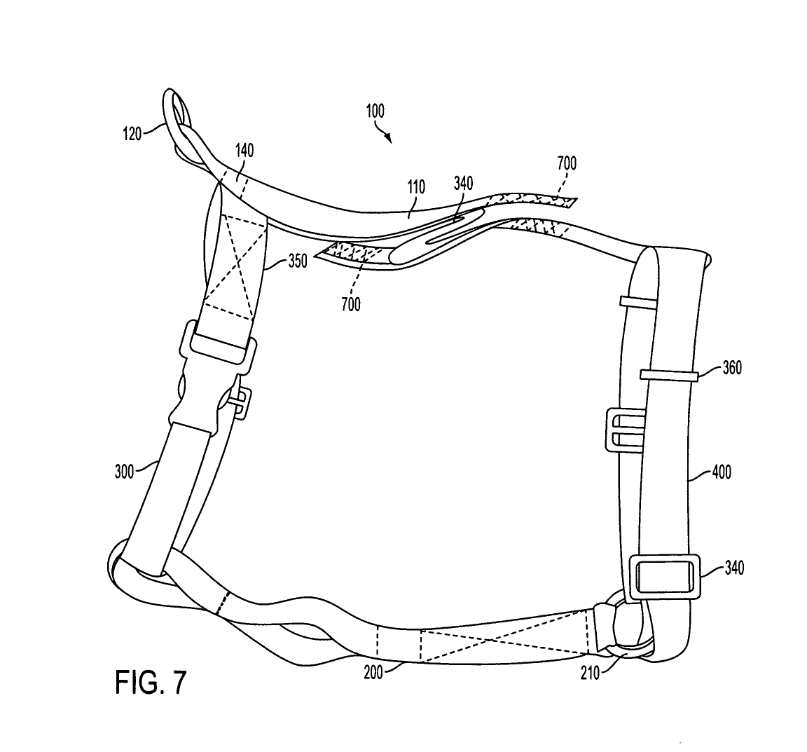

FIG. 7 shows an alternative embodiment of a harness according to the invention, wherein the back strap 110 is provided with a strap length adjuster 340 that maintains a connection between the neck strap 400 and waist strap 300 which is a benefit for harnesses made for difficult to control animals. The length adjuster 340 comprises at least one tongue 700 of material attached at one end of the back strap and which can be connected to a different end of the back strap. In one embodiment, the tongue 700 of material comprises a loop and hook connector, which can be connected to a complementary loop and hook connector on the back strap 110, and thereby permit a length of material of the back strap 110 to be doubled over and the length of the back strap 110 adjusted to fit the size of the animal. Preferably, in such an embodiment, a length adjuster 340 is provided on either side of the back strap to envelope the doubled-over portion of the back strap. In such an embodiment, the length 340 adjuster provides additional stiffness to the back strap 110, and maintains the connection between the neck strap 400 and waist strap 300.

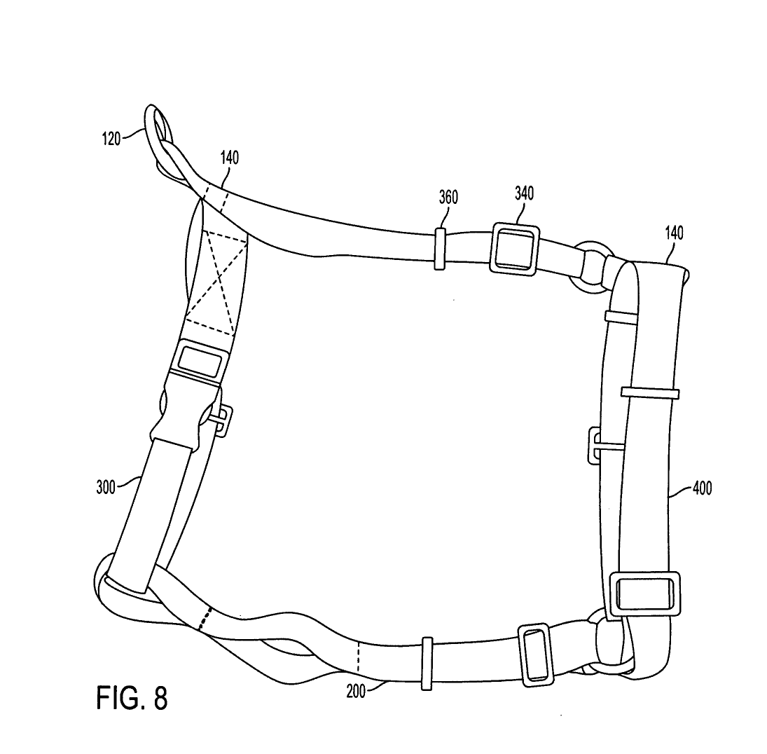

FIG. 8 shows an alternative embodiment of a harness according to the invention, wherein the back strap 110 is provided with a length adjuster 340 comprising a loop of material of the back strap 110 and a back strap slider 360. The back strap slider 360 can be a circular or rectangular ring which can receive a double-backed portion of the material of the back strap 110 or the strap length adjuster and provide a means for adjusting the length of the back strap 110 and locking the back strap 110 at a desired length.

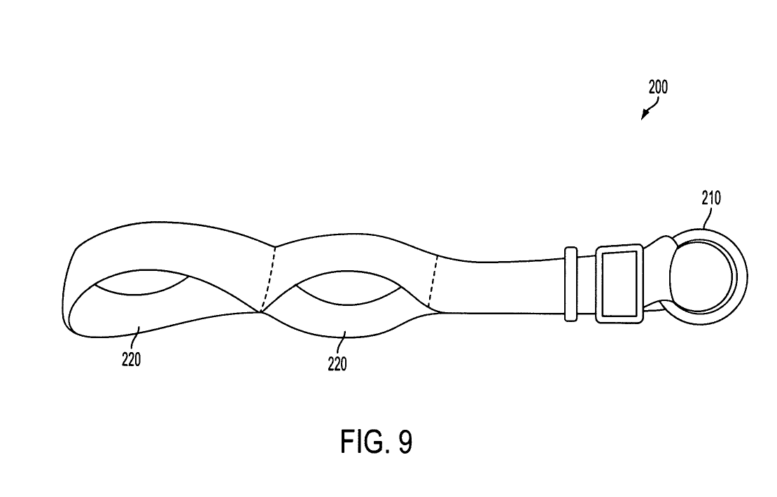

FIG. 9 shows an alternative embodiment of a belly strap 200, wherein the belly strap is provided with a length adjuster 340 comprising a loop of material of the belly strap 200 and an adjustable belly strap slider 360. The adjustable belly strap slider 360 can be a circular or rectangular ring which can receive a double-backed portion of the material of the belly strap 200 or the strap length adjuster 340 and provide a means for adjusting the length of the belly strap 200 and locking the belly strap at a desired length. It can be appreciated, that an embodiment of a belly strap 200 having a length adjust can be provided with just one loop 220.

By providing ring connectors at the neck and back strap, the harness provides comfort for dog and allowing freedom of movement of animal's head without sacrificing control. Control is provided with a fixed connection of the back strap to the waist strap, which also provides greater stability of the harness, which cooperates with the neck and belly strap to prevent the harness from shifting around the animal, and becoming tangled. Flexible connections for the belly and waist straps and by use of flexible webbing provide for additional comfort and adjustability. In addition, multiple loops at a belly strap can be provided for adjustability and for stability of connection. Two connections provide a better fit without imposing a significant amount of additional material. Waist strap buckle is positioned with male position at top part of loop where it can provide stability without discomfort.

1. An animal harness comprising:
a back strap,
a belly strap,
a waist strap, and
a neck strap,
wherein the back strap is fixedly connected to the waist strap, wherein the belly strap includes at least one belly strap connector, wherein the belly strap is slidably connected to the waist strap by the belly strap connector, wherein the belly strap is fixedly connected to the neck strap by a ring connector, and wherein the neck strap includes at least one neck strap adjuster.

2. An animal harness according to claim 1 wherein the back strap is fixedly connected to the neck strap at a midpoint of the neck strap

3. An animal harness according to claim 2 wherein the back strap is fixedly connected to the neck strap at a midpoint of the neck strap by a ring connector.

4. An animal harness according to claim 2 wherein the neck strap includes a neck strap stiffener at least a portion of the neck strap in connection with the back strap.

5. An animal harness according to claim 1 wherein the back strap includes a back strap attachment and a back strap stiffener.

6. An animal harness according to claim 5 wherein the back strap stiffener comprises a strap length adjuster.

7. An animal harness according to claim 6 wherein the strap length adjuster comprises at least one tongue disposed on one side of back strap and a hook and loop connector, wherein a portion of the hook and loop connector is disposed on a portion of the back strap.

8. An animal harness according to claim 6 wherein the strap length adjuster comprises a length of back strap material, a buckle, and a slider; wherein the length of back strap material is looped around the neck connector ring.

9. An animal harness according to claim 1 wherein the waist strap includes a strap length adjuster disposed at an end of the waist strap proximate said back strap and opposite said waist strap fastener.

10. An animal harness according to claim 5 further comprising waist strap stitching disposed proximate to and above the male connector.

11. An animal harness according to claim 1 wherein the belly strap includes a belly strap stiffener.

12. An animal harness according to claim 1 wherein the belly strap includes a strap length adjuster.

13. An animal harness according to claim 12 wherein the strap length adjuster comprises a length of belly strap material, a buckle, and a slider; wherein the length of belly strap material is looped around the belly strap attachment ring.

14. An animal harness according to claim 1 wherein the neck strap includes two neck strap length adjusters, each on either side of the neck strap, wherein each neck strap length adjuster comprises a length of neck strap material, a slider and a buckle, and wherein each neck strap length is adjustably connector to the belly strap attachment.

15. An animal harness according to claim 1 wherein the back strap and belly strap are fabricated from materials having different colors.
